(19) United States
(12) Patent Application Publication
(10) Pub. No.: US 2013/0291386 A1
(43) Pub. Date: Nov. 7, 2013

(54) PLASTIC PIPE PREPARATION TOOL

(71) Applicant: ASAHI/AMERICA, INC., Malden, MA (US)

(72) Inventors: Alex Gambino, Charlestown, MA (US); Conrad Williams, Salem, MA (US)

(73) Assignee: ASAHI/AMERICA, INC., Malden, MA (US)

(21) Appl. No.: 13/796,412

(22) Filed: Mar. 12, 2013

Related U.S. Application Data
(60) Provisional application No. 61/641,996, filed on May 3, 2012.

(51) Int. Cl. B23B 5/08

(52) U.S. Cl. CPC B23B 5/08
USPC 30/95

(57) ABSTRACT

A pipe cutting tool with a tubular housing having cylindrical inner and outer surfaces is provided. The housing includes first and second ends and a cylindrical opening extending from the first end towards the second end. A plurality of openings extend through the first end between the inner and outer surfaces. Blade mounting supports are defined between the openings. A plurality of L-shaped cutting blades are provided having a first leg to be disposed in the blade mounting support and a second leg projecting radially inward from the first leg at one end of the first leg. Inwardly facing edges of the legs of the blade are cutting edges for trimming the plastic pipe. The blade is dimensioned so that the cutting edge of the first leg will project slightly into the interior of the housing when the blade is mounted in the blade mounting support.

This application claims priority on U.S. Provisional Application No. 61/641,996 filed on May 3, 2012.

### BACKGROUND OF THE INVENTION

1. Field of the Invention

The invention relates to a tool that can be used to prepare an end portion of a plastic pipe for attachment to a fitting without using adhesives or solvents and without a threaded connection.

2. Description of the Related Art

Plastic pipes are known to exhibit high resistance to many corrosive chemicals. As a result, plastic pipes are employed widely in the chemical and petrochemical industries and in industries that use or produce corrosive materials as part of the manufacturing process. The particular plastic material used in a pipe system will be selected in accordance with the anticipated range of chemicals to be carried through the pipe. For example, polyvinyl chloride (PVC) resists attack by most acids and strong alkalis as well as gasoline, kerosene aliphatic alcohol, hydrocarbons and salt solutions. Polyvinylidene fluoride (PVDF) has superior chemical resistance and is used in many situations where PVC would not be appropriate. Chlorinated polyvinyl chloride (CPVC) has characteristics similar to PVC, but with a working temperature range that is higher than PVC. Polypropylene (PP) possesses excellent chemical resistance to many acids, alkalis and organic solvents. However, polypropylene is not recommended for use with chlorinated hydrocarbons and aromatics. Other plastics used in piping systems include ABS and glass-filled polypropylene (PPG) and polyethylene (PE).

Traditionally, plastic pipes have been joined to fit things by using an adhesive. The adhesive has been selected to react appropriately with the plastic of the pipe and the fitting. However, the adhesive can react poorly with the chemical that is being carried through the pipe system. As a result, a demand has been developing for a plastic pipe system that can be used without adhesive. Thermal welding offers considerable potential. However, a high quality welded connection requires the surfaces of the pipe and the fitting to be smooth, clean and free of oxides.

Various methods and tools have been developed for cleaning the end of a metal or plastic pipe to prepare the pipe for connection to a fitting. These methods and tools range from the simple use of an emery paper to more complex electrical and mechanical machines.

It is an object of the subject invention to provide a tool for efficiently preparing the end of a plastic pipe for non-adhesive connection to a fitting.

### SUMMARY OF THE INVENTION

The invention relates to a tool with a tubular housing having a substantially cylindrical inner surface and an outer surface that may also be substantially cylindrical. The inner surface has an inside diameter selected to slightly exceed the outside diameter of a plastic pipe that is to be prepared. The tubular housing has opposite first and second longitudinal ends. Three circumferentially spaced openings extend into the first end, but do not continue as far toward the second end as the cylindrical center opening. Thus, a shavings pocket is defined in the cylindrical center opening between the closed bottom ends of the respective openings and the closed bottom end of the center opening. Circumferentially spaced blade mounting supports are defined between the openings. A threaded aperture extends transversely through each blade mounting support. The housing preferably is formed from aluminum, but may be made of other metal, such as steel.

The tool of the subject invention further includes a plurality of cutting blades mounted respectively in the blade mounting supports. Each cutting blade preferably is a plate formed from a hardened steel and has opposite surfaces defining a thickness selected so that the blades can be received respectively in the blade mounting supports in the tubular housing. Each blade further includes an aperture that aligns with the threaded aperture of the respective blade mounting support when the blade is mounted in the blade mounting support. The respective blades are substantially L-shaped and include a first leg to be disposed in the blade mounting support and a second leg projecting radially inward from the first leg at one end of the first leg. Thus, the first and second legs define a concave inner corner. The inner corner may be chamfered. A projecting distance of the second leg from the first leg preferably exceeds the thickness of the plastic pipe with which the tool will be used. Edges of the legs of the blade on the concave side of the blade are cutting edges for trimming the plastic pipe. The blade is dimensioned so that the cutting edge of the first leg will project slightly into the interior of the tubular housing when the blade is mounted properly in the blade mounting support. Similarly, the second leg will project farther into the interior of the tubular housing when the blade is mounted properly in the housing.

The tool further includes a plurality of threaded bolts that are used to attach the respective blades to the tubular housing. The bolts have threaded ends that pass through the aperture of the blade and are threaded into engagement with the respective bore for securely holding the respective blades in the housing.

The tool is used by inserting the end of a plastic pipe into the tubular housing until the pipe contacts the blades. The tubular housing then is rotated relative to the pipe so that a small part of the outer circumferential surface of the pipe and a small part of the axial end of the pipe are cut respectively by the cutting edges of the first and second legs of the respective blades. Rotation of the tubular housing can be facilitated by the surface configuration defined by the outer surface of the tubular housing, by handles projecting out from the tubular housing or by a configuration for engaging a rotatable tool, such as a drill.

### BRIEF DESCRIPTION OF THE DRAWINGS

FIG. 1 is a perspective view of a plastic pipe preparation tool with a pipe inserted therein in accordance with the invention.

FIG. 2 is a side elevational view of the pipe preparation tool of FIG. 1.

FIG. 3 is a cross-sectional view taken along line 3-3 in FIG. 2.

FIG. 4 is a cross-sectional view taken along line 4-4 of FIG. 2.

FIG. 5 is a cross-sectional view of the plastic pipe preparation tool shown in FIG. 1 without a pipe inserted therein.

FIG. 6 is a top plan view of the pipe preparation tool of FIG. 5.

FIG. 7 is a side elevational view of a plastic pipe preparation tool without a pipe inserted therein.

FIG. 8 is a cross-sectional view taken along line 8-8 of FIG. 8.

FIG. 9 is a cross-sectional view taken along line 9-9 in FIG. 7.

FIG. 10 is a side-elevational view of a cutting blade of the tool shown in FIG. 1.

FIG. 11 is a front elevational view of the cutting blade shown in FIG. 10.

### DETAILED DESCRIPTION OF THE PREFERRED EMBODIMENT

All examples and conditional language recited herein are intended for teaching purposes to aid the reader in understanding the principles of the disclosure and the concepts contributed by the inventor to furthering the art, and are to be construed as being without limitation to such specifically recited examples and conditions.

Moreover, all statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

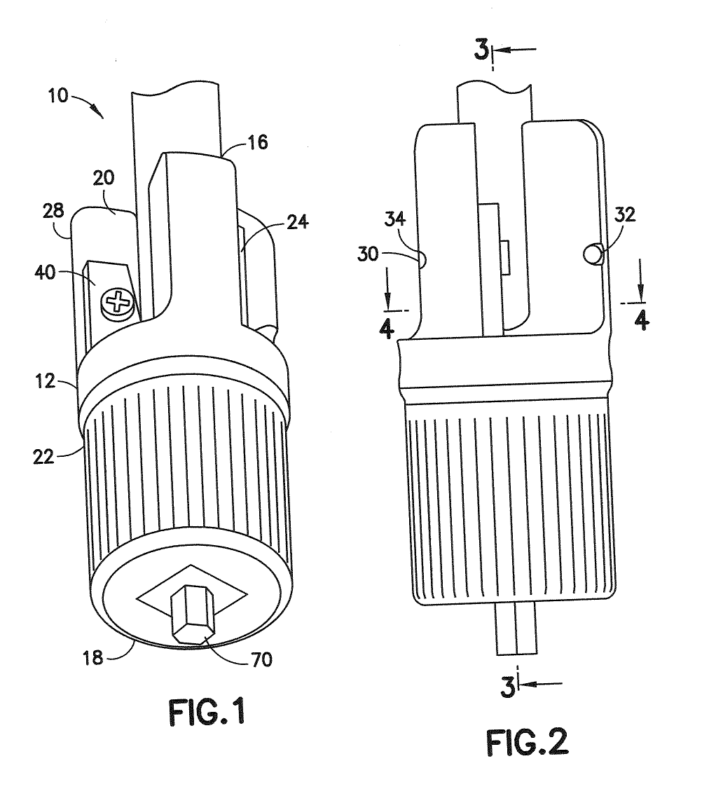

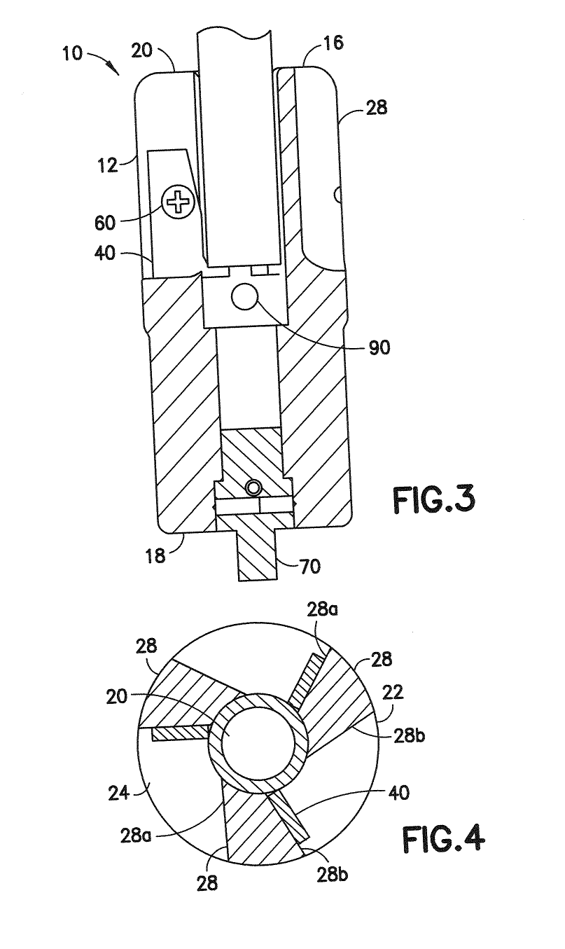

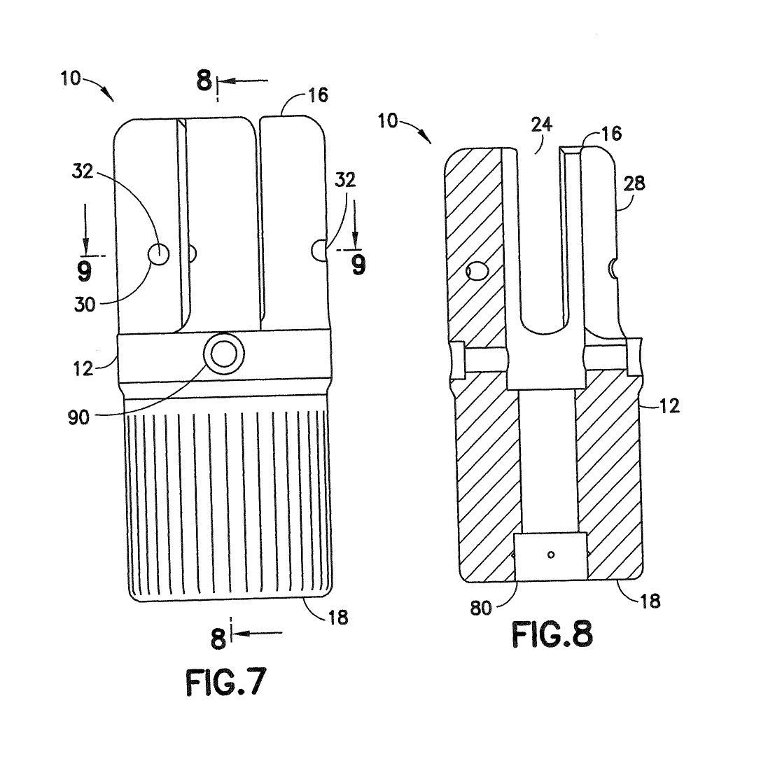

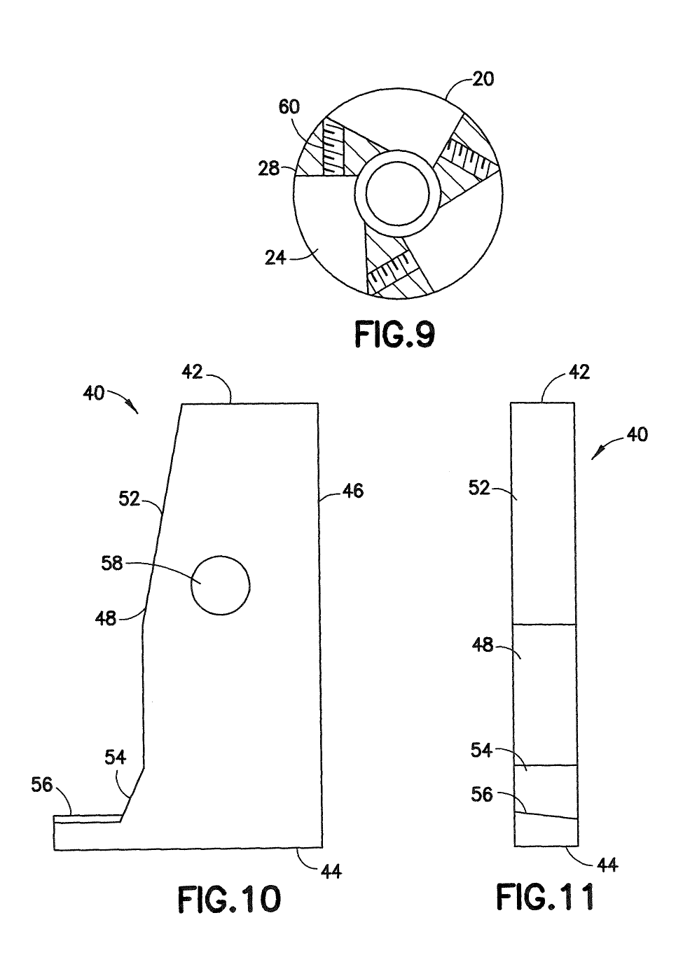

A plastic pipe preparation tool in accordance with the invention is identified generally by the 10 in FIGS. 1-9. The tool 10 includes a tubular housing 12 formed from a metal material, such as aluminum, and includes opposite first and second ends 16 and 18. A cylindrical opening 20 extends into the first end 16, but does not continue entirely to the second end 18. The cylindrical opening 20 has an inside diameter selected in accordance with the outside diameter of the plastic pipe that is to be prepared. The housing 12 also has an outer circumferential surface 22. Parts of the outer circumferential surface 22 in proximity to the second end 18 include gnarling to facilitate manipulation of the housing 12. A square or polygonal protuberance 70 projects from the second end 18 and can be inserted into and engage with a correspondingly configured drive member of a drill or other rotating tool. In an alternate embodiment as shown in FIGS. 7-9, a square or polygonal opening 80 extends into the second end 18 and can accommodate a correspondingly configured drive member of a drill or other rotating tool.

Three circumferentially spaced blade mounting openings 24 extend into the first end 16, but do not continue as far toward the second end 18 as the cylindrical center opening 20. Thus, a shavings pocket 26 is defined in the cylindrical center opening 20 between the closed bottom ends of the respective openings 24 and the closed bottom end of the center opening 20. The openings 24 extend through an arc of about 90°. As a result, small circumferentially spaced blade supports 28 are defined between the openings 24. Each blade support 28 has first and second planar surfaces 28a and 28b aligned substantially parallel to the longitudinal or rotational axis of the housing 12 and inner and outer circumferential surfaces. The inner circumferential surface is part of the center pipe mounting opening 20. A bore 30 extends transversely through each blade support 28 from the first surface 28a to the second surface 28b and is aligned normal to the first surface 28a. The first surfaces 28a of the blade supports 28 are separated from one another by about 120°. Additionally, the first and second surfaces 28a, 28b that border each blade mounting opening 24 are separated from one another by about 90°. Additionally, threaded apertures 90 extend radially into the outer circumferential surface 20 housing 12 at positions between the blade mounting openings 24 and the second end 18 of the housing 12 and can threadedly receive handles (not shown) to facilitate manual rotation of the tool 10.

The tool 10 further includes three blades 40 mounted respectively in the blade mounting supports 28 of the holder. More particularly, each blade 40 is formed from a planar piece of hardened steel with a thickness dimension substantially equal to the width of each blade mounting support 28. More particularly, each blade 40 has opposite first and second ends 42 and 44 and a non-cutting outer edge 46 extending linearly between the ends 42 and 44. The side of the cutting blade 40 opposite the non-cutting outer edge 46 defines a compound cutting edge identified generally by the numeral 48. The compound cutting edge 48 is configured so that the entire blade defines a generally L-shaped, as shown in FIG. 10. The compound cutting edge 48 includes a first chamfer 50 extending from the first end 42 and aligned to extend farther away from the non-cutting outer edge 46 at greater distances from the first end 42. A side cutting edge 52 extends from the first chamfer 50 toward the second end 44 of the cutting blade 40 and is aligned substantially parallel to the non-cutting outer edge 46. A second chamfer 54 extends from the end of the side cutting edge 52 remote from the first end 42 of the blade 40 and is sloped to increase the distance from the non-cutting outer edge 46 at farther distances from the first end 42 of the blade 40. An end cutting-edge 56 extends from the end of the second chamfer 54 remote from the first end 42 of the blade 40 and is aligned substantially perpendicular to the side cutting edge 52. The end cutting-edge 56 is spaced from the second end of the blade 40 by approximately 0.10 inch. An aperture 58 is formed through the blade 40 at a location spaced from the first end 42 of the blade 40 by about 0.50 inch.

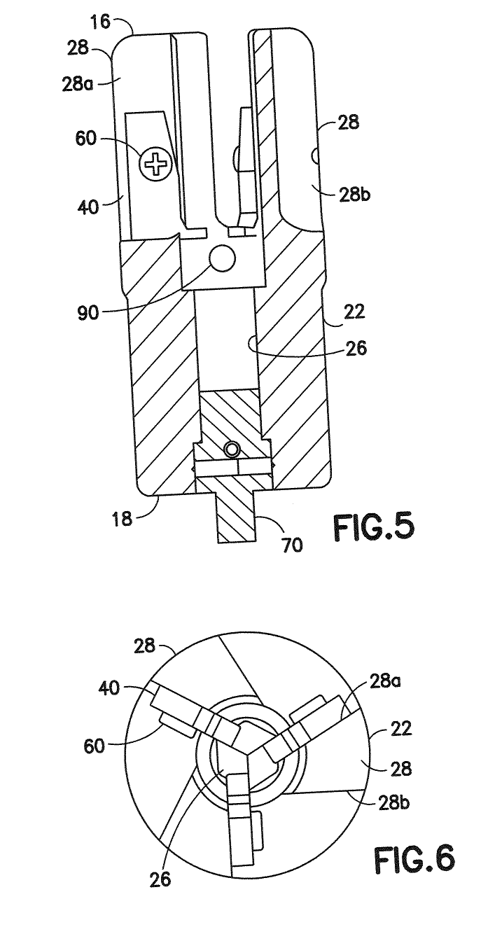

The tool 10 is assembled by inserting the second ends 44 of the respective blades 40 into the openings 24 and into engagement with the base of each openings. The blades 40 are oriented so that the non-cutting outer edges 46 are substantially parallel with the outer circumferential surface of the housing 12 and so that the compound cutting edge 48 projects into the cylindrical opening 20 of the housing 12, as shown in FIGS. 5 and 6. Additionally, the aperture 58 in each blade 40 will align with the bore 30 in the housing 12 when the blade 40 is mounted in the blade mounting support 28. Screws 60 then are passed through the entry 32 of each bore 30, through the aperture 58 of each blade 40 and are threaded into the exit 34 of the respective bore 30.

The tool 10 is used by telescoping the first end 16 of the housing 12 over the end of a plastic pipe and rotating the tool about the axes of the pipe and the housing 12. The blades 40 will gradually peel a thin layer of plastic from the outer circumferential surface and the end surface of the plastic pipe as the tool 10 is rotated and advanced over the pipe. Additionally, the gradual peeling of plastic from the pipe will form a first chamfer at the interface between the cut and uncut parts of the pipe and a second chamfer adjacent the end of the pipe. The amount of plastic removed from the pipe is sufficient to peel any oxide layer from the pipe and to provide a smooth surface for efficient non-adhesive connection of the pipe to a fitting.

Although the disclosure herein has been described with reference to particular illustrative embodiments, it is to be understood that these embodiments are merely illustrative of the principles and applications of the present disclosure. Therefore numerous modifications may be made to the illustrative embodiments and other arrangements may be devised without departing from the spirit and scope of the present disclosure, which is defined by the appended claims.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A plastic pipe preparation tool, comprising:
a housing with opposite first and second ends and spaced apart along a longitudinal axis, an outer circumferential surface extending between the ends, a pipe mounting opening formed in the first end and extending at least partially through the housing towards the second end, at least one blade mounting opening extending radially from the pipe mounting opening to the outer circumferential surface, at least one blade support defined adjacent the blade mounting opening, and at least one bore extending secantally into the blade support; and
at least one L-shaped blade mounted in the blade mounting opening and to the blade support, the at least one blade having a side-cutting edge aligned parallel to the longitudinal axis and projecting into the pipe mounting opening, and an end-cutting edge substantially normal to the side-cutting edge and disposed in the pipe mounting opening of the housing.

2. The plastic pipe preparation tool of claim 1, further comprising:
a first chamfer formed between the side-cutting edge and the end-cutting edge.

3. The plastic pipe preparation tool of claim 1, further comprising:
an aperture formed through the at least one blade and configured to align with the at least one bore when the blade is mounted in the at least one slot.

4. The plastic pipe preparation tool of claim 3, further comprising at least one screw inserted through the at least one bore and the aperture of the at least one blade.

5. The plastic pipe preparation tool of claim 1, wherein the at least one blade has a non-cutting outer edge aligned with the outer circumferential surface of the housing.

6. The plastic pipe preparation tool of claim 1, wherein the at least one blade mounting opening comprises three blade mounting openings spaced circumferentially about the tubular housing and defining three blade supports, the at least one blade comprises three blades configured to be mounted to the three blade supports.

7. The plastic pipe preparation tool of claim 1, wherein the at least one bore comprises three bores.

8. The plastic pipe preparation tool of claim 1, further comprising gnarled portions formed on the circumferential surface near the second end.

9. The plastic pipe preparation tool of claim 1, further comprising an opening formed in the second end and configured for accommodating a drive member.

10. The plastic pipe preparation tool of claim 1, further comprising a protuberance formed on the second end and configured for mating with a drive member.

11. The plastic pipe preparation tool of claim 1, further comprising a shavings pocket in the housing between the blade and the second end for collecting pipe shavings.

12. The plastic pipe preparation tool of claim 1, further comprising a plurality of handle mounting apertures extending radially into the housing.

13. A plastic pipe preparation tool, comprising:
a housing with opposite first and second ends spaced apart along a rotational axis, a pipe mounting opening extending into the first end and substantially along the rotational axis, a plurality of circumferentially spaced blade supports adjacent the first end of the housing and outward of the pipe mounting opening, blade mounting openings being defined between the blade supports that are circumferentially adjacent to one another, bores extending secantally into the blade supports and opening at the respective blade mounting openings; and
L-shaped blades mounted respectively to the blade supports at the blade mounting openings, each of the blades having a side-cutting edge aligned parallel to the rotational axis and projecting into the pipe mounting opening, and an end-cutting edge substantially aligned angularly to the side-cutting edge and disposed in the pipe mounting opening of the housing.

14. The plastic pipe preparation tool of claim 13, wherein the plurality of blade supports comprise three blade supports substantially equiangularly spaced around the housing.

15. The plastic pipe preparation tool of claim 14, wherein each blade support has a first and second surfaces aligned parallel to the rotational axis, the blades being mounted respectively on the first surfaces of the blade supports.

16. The plastic pipe preparation tool of claim 15, wherein the first surfaces of the blade supports are separated from one another by about 120°.

17. The plastic pipe preparation tool of claim 15, wherein each blade mounting opening is defined by the first surface of one blade support and a second surface of another of the blade supports, the first and second surfaces defining each blade mounting opening being substantially normal to one another.

18. The plastic pipe preparation tool of claim 17, wherein the each of the bores extends from the first surface of the respective blade support to the second surface thereof.

19. The plastic pipe preparation tool of claim 17, wherein the each of the bores is substantially normal to the first surface of the respective blade support.
